(19) United States
(12) Patent Application Publication
(10) Pub. No.: US 2009/0043602 A1
(43) Pub. Date: Feb. 12, 2009

(54) METHOD FOR INCREASING THE AWARENESS AND EXPOSURE OF A BRAND

(75) Inventor: Steve WHEELER, Cleveland, OH (US)

Correspondence Address: HAHN LOESER & PARKS, LLP, One GOJO Plaza, Suite 300, AKRON, OH, 44311-1076, US

(73) Assignee: LIGGETT-STASHOWER, INC., Cleveland, OH (US)

(21) Appl. No.: 12/188,049

(22) Filed: Aug. 7, 2008

Related U.S. Application Data
(60) Provisional application No. 60/954,485, filed on Aug. 7, 2007.

(51) Int. Cl. G06Q 30/00

(52) U.S. Cl. 705/1

(57) ABSTRACT

A method for increasing the awareness and exposure of a brand including providing a plurality of competitive activities each capable of ascertaining a winner from among entrants, each competitive activity providing a contest utilizing a contest product, providing a sponsor having a brand-name product, selecting from the plurality of competitive activities one or more competitive activities where the brand-name product is related to the contest product, providing advertising opportunities to the sponsor associated with the competitive activity, inviting a plurality of entrants to compete in the competitive activity, and ascertaining a winner from among entrants by conducting the competitive activity. The competitive activities may include performing a task related to a trade, and the brand-name product may be associated with the trade. The brand-name product may be used in the competitive activity.

### BACKGROUND AND SUMMARY

The present disclosure relates to a method for increasing the awareness and exposure of a brand. Brands, or trademarks, are used by consumers to identify a company that manufactured a product and to distinguish between products. Companies safeguard their brands and the reputation of their brands because consumers may associate brands with attributes or qualities of a product, such as quality and durability. Therefore, it may be advantagous for a company to expose its brands to consumers who use its products to create brand awareness and a positive brand image. Further, companies may wish to increase brand awareness and exposure of a brand to targeted consumers who buy and or use the company's products.

Accordingly, there remains a need for a method that increases the awareness and exposure of a brand.

The presently disclosed method for increasing the awareness and exposure of a brand may include providing a plurality of competitive activities each capable of ascertaining a winner from among entrants, each competitive activity providing a contest utilizing a contest product; providing a sponsor having a brand-name product; selecting from the plurality of competitive activities one or more competitive activities where the brand-name product is related to the contest product; providing advertising opportunities to the sponsor associated with the competitive activity; inviting a plurality of entrants to compete in the competitive activity; and ascertaining a winner from among entrants by conducting the competitive activity.

Alternately, a method for increasing the awareness and exposure of a brand utilizing a plurality of competitive activities each capable of ascertaining a winner from among entrants, each competitive activity providing a contest utilizing a contest product, may include providing a brand-name product; selecting from the plurality of competitive activities one or more competitive activities where the brand-name product is related to the contest product; sponsoring the competitive activity; and providing at least one marketing activity associated with the event.

In yet another alternate, a method for increasing the awareness and exposure of a brand may include providing a computer operably connected to a database including a plurality of competitive activities each capable of ascertaining a winner from among entrants, each competitive activity providing a contest utilizing a contest product, each competitive activity associated with at least one contest product in the database; providing a sponsor having a brand-name product; selecting contest products related to the brand-name product; selecting from the database one or more competitive activities associated with the selected contest product; providing advertising opportunities to the sponsor associated with the competitive activity; inviting a plurality of entrants to compete in the competitive activity; and ascertaining a winner from among entrants by conducting the competitive activity.

The competitive activities may include a contest based on at least one attribute selected from the group consisting of skill, speed, strength and endurance. Alternately or in addition, the competitive activities include performing a task related to a trade. The brand-name product may be associated with the trade, and optionally, the brand-name product may be operable as the contest product.

The competitive activities may include performing a task related to a trade selected from the group consisting of framing carpentry, finish carpentry, roofing, electricity, plumbing, drywall finishing, painting, concrete construction, mill-working, and landscaping.

The advertising opportunities may include at least one selected from the group consisting of signage, mailers, advertisements, product placement, clothing, internet advertising, logo placement, and promotional products. Alternately or in addition, the marketing activity may include at least one selected from the group consisting of product demonstration, trade show display, and retailing.

### DETAILED DESCRIPTION OF THE DISCLOSURE

The present disclosure provides a method for a company to expose one or more of the company's brands to certain consumers to increase the consumers' awareness of the brand or brands. The method includes an event having one or more competitive activities in which entrants may compete. The event is used as a forum for product and brand advertising, promotion, product demonstration, and other event marketing and advertising activities for increasing the awareness and exposure of a brand.

The event may be organized and coordinated by an organizer. The organizer may manage program logistics, such as provide a venue with sets, staging, seating, and other features as desired, obtain municipal licenses or permits and insurance, organize security, provide entertainment, and other event management logistics. The organizer may invite people to compete in the competitive activities as entrants.

The organizer may obtain company sponsors. The sponsoring company may be a company that sells one or more brand-name products related to the event. The sponsoring company may sponsor the event, or the sponsoring company may sponsor one or more competitive activities within the event. In yet another alternate, the company may sponsor other aspects of the event, such as promotional materials, the venue, televising or other media, or other aspects of the event. The sponsoring company may use the sponsorship to promote the company's brands and brand-name products. Alternately or in addition, retail stores and product distributors may be sponsors. The sponsor may invite people to compete in the competitive activities as entrants.

The organizer may provide to the sponsoring companies, or sponsors, various opportunities for increasing the awareness and exposure of the sponsor's brand. The organizer may provide advertising opportunities to the sponsor associated with the event and/or competitive activity, such as signage, mailers, advertisements, product placement, clothing, internet advertising, logo placement, promotional products, and any other advertising or brand placement to feature the brand. The amount of sponsor advertising associated with the event may be determined by an amount of sponsorship money provided by the sponsor. The venue may be provided by a sponsor, such as a home center, building company, lumber yard, or other suitable venue.

At the event, entrants may compete in the competitive activities for prizes. The competitive activities may include entrants performing tasks related to a trade. Examples of a trade include framing carpentry, finish carpentry, roofing, electricity, plumbing, drywall finishing, painting, concrete construction, mill-working, landscaping, and other trades. The event may include a plurality of competitive activities, and each competitive activity may be selected to utilize skills of different trades.

The competitive activities may be selected based on the sponsors and the brand-name products that the sponsors sell. The sponsoring company's brand-name product may be associated with the trade. For example, a sponsor that sells hammers may sponsor a competitive activity related to hammers or using a hammer, such as associated with roofing or framing carpentry trades. The sponsor's advertising may include advertising and promotion related to the sponsored competitive activity. Optionally, the sponsor's brand-name product may be used in the contest.

The competitive activities may include industry-specific contests having names such as Joist & Bridge Shootout, Floor-It Nail-It, Framer's Frenzy, Glue & Screw, Sider's Challenge, Monster Hammer, Speed Screwing, Caulk Like a Painter, Pattern Cut-Off, Raise A Little Roof, Shingle Showdown, and any other competitive activities. The competitive activity named Joist & Bridge Shootout may include activities such as nailing floor joists and bridging inside a specific foundation dimension, which may utilize nail guns or hammers. The competitive activity named Floor-It Nail-It may include activities such as applying sub floor sheeting to floor joists of a specific foundation dimension. The competitive activity named Framer's Frenzy may include activities such as framing a wall of a specific square footage, with window and door openings, packing headers, and setting it in place. The competitive activity named Glue & Screw may include activities such as hanging drywall on studs on a wall having a designated size. The competitive activity named Sider's Challenge may include activities such as hanging siding on a wall having a designated size. The competitive activity named Monster Hammer may include activities such as driving a series of spikes, by hand, using monster 20 oz hammers. The competitive activity named Speed Screwing may include activities such as driving in a 5″ wood screw by hand. The competitive activity named Caulk Like a Painter may include activities such as applying a bead of caulk for sealing the sidings of doors and windows. The competitive activity named Pattern Cut-Off may include activities such as sawing ten (10) complete roof rafters from a designated roof rafter pattern. The competitive activity named Raise A Little Roof may include activities such as raising and nailing roof rafters, and then nailing plywood into position over the rafters. The competitive activity named Shingle Showdown may include activities such as taking five (5) squares of shingles up a ladder, and then laying them over a roof's ridge-board. The competitive activities mentioned above are for purposes of illustrating examples of competitive activities included in the present method, and not for purposes of limiting the same. The competitive activities may include a contest based on attributes such as skill, speed, strength, endurance, and any other competitive attribute.

The event may be a multiple day event, such as a weekend, or longer. Alternately, the event may be a one-day event. In addition, the event may be repeated in more than one location. The competitive activities at certain events may be used as qualifying rounds, leading to a regional or national event to determine winning entrants for the region or nation.

The presently disclosed method for increasing the awareness and exposure of a brand may include securing sponsorship from at least one related sponsors and/or partner; engaging in a promotional program comprising at least one marketing activity, such as paid advertising, public relations, direct marketing, or event marketing; inviting a plurality of individuals to participate as entrants in a plurality of industry-specific competitive events; defining competitive events, rules, and regulations of participation in the events; conducting the plurality of competitive events in the presence of consumers at one or more competition venues; and awarding prizes to at least one winning entrant in each of the plurality of competitive events, the at least one marketing activity featuring the sponsor's brand.

The industry-specific competitive activities may be selected relating to the construction industry, the home building industry, the home remodeling industry, the home renovating industry, and/or the landscaping industry.

The presently disclosed method of increasing awareness and exposure of a brand may include providing a plurality of competitive activities each capable of ascertaining a winner from among entrants, each competitive activity providing a contest utilizing a contest product; providing a sponsor having a brand-name product; selecting from the plurality of competitive activities one or more competitive activities where the brand-name product is related to the contest product; providing advertising opportunities to the sponsor associated with the competitive activity; inviting a plurality of entrants to compete in the competitive activity; and ascertaining a winner from among entrants by conducting the competitive activity. The entrants may include an individual or a team of individuals.

Alternately, the present method may include providing a brand-name product; selecting from the plurality of competitive activities one or more competitive activities where the brand-name product is related to the contest product; sponsoring the competitive activity; and providing at least one marketing activity associated with the event.

In yet another alternate, the present method may include providing computer operably connected to a database including a plurality of competitive activities each capable of ascertaining a winner from among entrants, each competitive activity providing a contest utilizing a contest product, each competitive activity associated with at least one contest product in the database; providing a sponsor having a brand-name product; selecting contest products related to the brand-name product; selecting from the database one or more competitive activities associated with the selected contest product; providing advertising opportunities to the sponsor associated with the competitive activity; inviting a plurality of entrants to compete in the competitive activity; and ascertaining a winner from among entrants by conducting the competitive activity.

As previously discussed, the advertising opportunities may include signage, mailers, advertisements, product placement, clothing, internet advertising, logo placement, promotional products, and any other advertising impression that may be realized by persons of ordinary skill in the art. Sponsors may conduct marketing activities at the event, such as product demonstration, trade show display, retailing, and any other marketing activity.

The presently disclosed method may be used to increase awareness and exposure of the sponsor's brands. Advertising and brand exposure may strengthen retail and distribution relationships, such as with sales representatives, distributors, dealers, direct retail accounts. In addition, the event may enable incremental sales for the brand-name products.

While the invention has been described with detailed reference to one or more embodiments, the disclosure is to be considered as illustrative and not restrictive. Modifications and alterations will occur to those skilled in the art upon a reading and understanding of this specification. It is intended to include all such modifications and alterations in so far as they come within the scope of the claims, or the equivalents thereof.

What is claimed is:

1. A method for increasing the awareness and exposure of a brand comprising:
providing a plurality of competitive activities each capable of ascertaining a winner from among entrants, each competitive activity providing a contest utilizing a contest product;
providing a sponsor having a brand-name product;
selecting from the plurality of competitive activities one or more competitive activities where the brand-name product is related to the contest product;
providing advertising opportunities to the sponsor associated with the competitive activity;
inviting a plurality of entrants to compete in the competitive activity; and
ascertaining a winner from among entrants by conducting the competitive activity.

2. The method of claim 1, where the competitive activities include a contest based on at least one attribute selected from the group consisting of skill, speed, strength and endurance.

3. The method of claim 1, where the competitive activities include performing a task related to a trade.

4. The method of claim 2, where the brand-name product is associated with the trade.

5. The method of claim 1, where the brand-name product is operable as the contest product.

6. The method of claim 1, where the competitive activities include performing a task related to a trade selected from the group consisting of framing carpentry, finish carpentry, roofing, electricity, plumbing, drywall finishing, painting, concrete construction, mill-working, and landscaping.

7. The method of claim 1, where the advertising opportunities include at least one selected from the group consisting of signage, mailers, advertisements, product placement, clothing, internet advertising, logo placement, and promotional products.

8. A method for increasing the awareness and exposure of a brand utilizing a plurality of competitive activities each capable of ascertaining a winner from among entrants, each competitive activity providing a contest utilizing a contest product; the method comprising:
providing a brand-name product;
selecting from the plurality of competitive activities one or more competitive activities where the brand-name product is related to the contest product;
sponsoring the competitive activity; and
providing at least one marketing activity associated with the event.

9. The method of claim 8, where the competitive activities include a contest based on at least one attribute selected from the group consisting of skill, speed, strength and endurance.

10. The method of claim 8, where the competitive activities include performing a task related to a trade.

11. The method of claim 10, where the brand-name product is associated with the trade.

12. The method of claim 8, where the brand-name product is operable as the contest product.

13. The method of claim 8, where the competitive activities include performing a task related to a trade selected from the group consisting of framing carpentry, finish carpentry, roofing, electricity, plumbing, painting, concrete construction, and mill-working.

14. The method of claim 8, where the marketing activity includes at least one selected from the group consisting of product demonstration, trade show display, and retailing.

15. A method for increasing the awareness and exposure of a brand comprising:
providing computer operably connected to a database including a plurality of competitive activities each capable of ascertaining a winner from among entrants, each competitive activity providing a contest utilizing a contest product, each competitive activity associated with at least one contest product in the database;
providing a sponsor having a brand-name product;
selecting contest products related to the brand-name product;
selecting from the database one or more competitive activities associated with the selected contest product;
providing advertising opportunities to the sponsor associated with the competitive activity;
inviting a plurality of entrants to compete in the competitive activity; and
ascertaining a winner from among entrants by conducting the competitive activity.

16. The method of claim 15, where the competitive activities include a contest based on at least one attribute selected from the group consisting of skill, speed, strength and endurance.

17. The method of claim 15, where the competitive activities include performing a task related to a trade.

18. The method of claim 17, where the brand-name product is associated with the trade.

19. The method of claim 15, where the brand-name product is operable as the contest product.

20. The method of claim 15, where the advertising opportunities include at least one selected from the group consisting of signage, mailers, advertisements, product placement, clothing, internet advertising, logo placement, and promotional products.
